(19) United States
(12) Patent Application Publication
(10) Pub. No.: US 2008/0280566 A1
(43) Pub. Date: Nov. 13, 2008

(54) WIRELESS COMMUNICATION APPARATUS WITH BUILT-IN CHANNEL EMULATOR/NOISE GENERATOR

(76) Inventors: Kuang-Yu Yen, Tai-Chung City (TW); Jiun-Hung Yu, Nan-Tou Hsien (TW); Der-Zheng Liu, Hsinchu County (TW); Tsung-Chun Cheng, Taipei County (TW); Yung-Ting Chen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 12/116,219

(22) Filed: May 7, 2008

(30) Foreign Application Priority Data
May 7, 2007 (TW) 096116093

(51) Int. Cl. H04B 17/00; H04L 27/28

(52) U.S. Cl. 455/67.11; 375/260; 375/224

(57) ABSTRACT

The invention provides a wireless communication apparatus with performance simulation function. The wireless communication apparatus includes a channel emulator and at least one noise generator; therefore a real transmission environment can be simulated inside the wireless communication apparatus to thereby accelerate the testing process. Moreover, as this invention sets a random noise generator in front of the FFT, an approximate AWGN effect will be generated when the wireless communication apparatus is under test.

### BACKGROUND OF THE INVENTION

1. Field of the Invention

The present invention relates to a wireless communication apparatus, and more particularly, to a wireless communication apparatus with a channel emulator or a noise generator.

2. Description of the Prior Art

In a conventional testing process, a fixed pattern is first fed into a communication chip, and then compared with a demodulation result of the communication chip to verify whether the modulating/demodulating function of the communication chip is normal. Usually, a transmitter and receiver inside the communication chip are connected to each other by a loopback to accelerate the testing process. In this way, the testing process does not require external circuits. The interior of the communication chip is equal to an ideal communication environment if there is no interference source disposed in the loopback. The conditions for testing the communication chip are therefore not real conditions for signal transmission, causing the communication chip fail to reach the desired functions when the communication chip is utilized in a real environment.

### SUMMARY OF THE INVENTION

One objective of the present invention is therefore to provide a wireless communication apparatus with performance simulation function. By building a channel emulator and a noise generator inside the wireless communication apparatus, an external signal transmission environment is simulated in the interior of the communication chip to accelerate the testing process for mass production and evaluate the performance of the wireless communication apparatus when the wireless communication apparatus is developed.

According to an exemplary embodiment of the present invention, a network communication apparatus is disclosed. The network communication apparatus comprises a transmitted data processing unit, for processing transmitted data to output a processed signal; a channel simulating unit, coupled to the transmitted data processing unit, for simulating status of a channel and performing channel simulation on the processed signal outputted by the transmitted data processing unit to generate a simulated signal; and a selecting unit receiving the processed signal and the simulated signal, for selectively outputting one of the processed signal and the simulated signal according to a selecting signal, wherein when the network communication apparatus is under test, the selecting unit outputs the simulated signal according to the selecting signal, and when the network communication apparatus is utilized to transmit signals, the selecting unit outputs the processed signal according to the selecting signal.

According to another exemplary embodiment of the present invention, a network communication apparatus is disclosed. The network communication apparatus comprises a transmitted data processing unit, for processing transmitted data to output a processed signal; a channel simulating unit, coupled to the transmitted data processing unit, for simulating status of a channel and performing channel simulation on the processed signal outputted by the transmitted data processing unit to generate a simulated signal; and a received data processing unit, for processing the simulated signal outputted by the channel simulating unit to output an outputted data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication apparatus under a test mode according to an exemplary embodiment of the present invention.

FIG. 2 is a diagram of a channel emulator shown in FIG. 1 according to the exemplary embodiment of the present invention.

FIG. 3 is a diagram of a binary noise generator implemented in the wireless communication apparatus of FIG. 1 according to the exemplary embodiment of the present invention.

FIG. 4 is a diagram of a wireless communication apparatus according to another exemplary embodiment of the present invention.

FIG. 5 is a diagram of a channel emulator according to another exemplary embodiment of the present invention.

### DETAILED DESCRIPTION

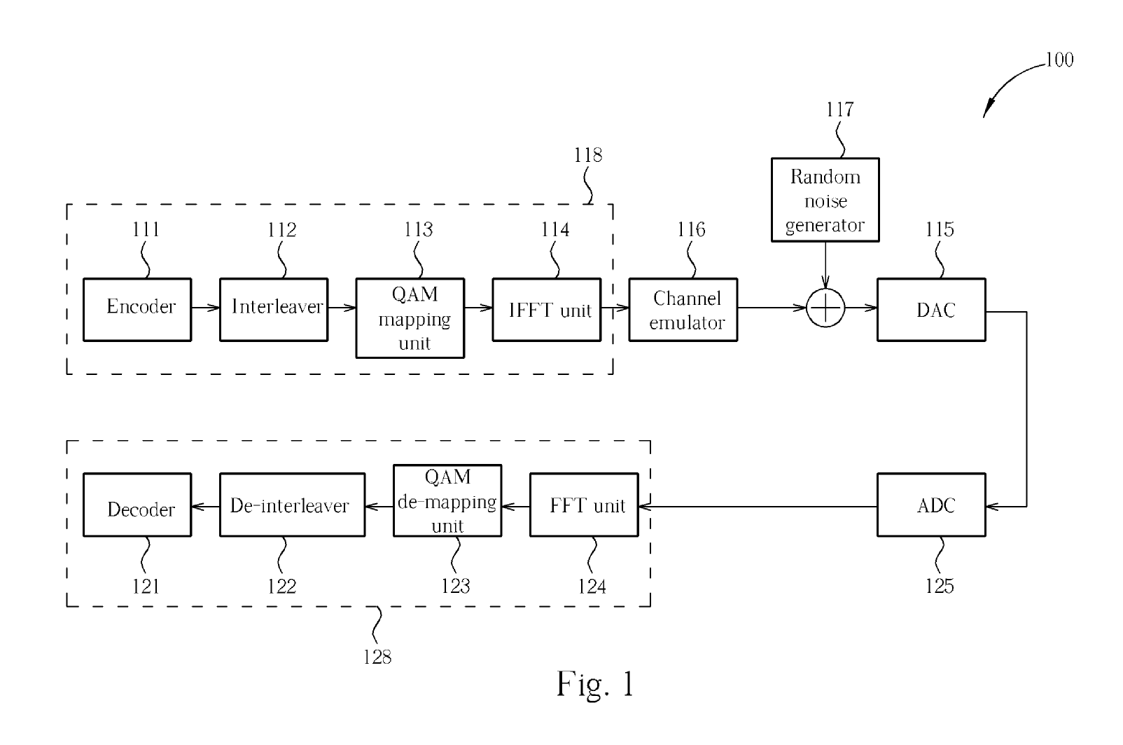

Please refer to FIG. 1, which is a diagram of a wireless communication apparatus 100 under a test mode according to an exemplary embodiment of the present invention. As shown in FIG. 1, the wireless communication apparatus 100 takes an example of a single input single output (SISO) orthogonal frequency division multiplexing (OFDM) system and comprises a transmitted data processing unit 118, a channel emulator 116, a random noise generator 117, a digital-to-analog converter (DAC) 115, an analog-to-digital converter (ADC) 125 and a received data processing unit 128. The transmitted data processing unit 118 comprises an encoder 111 for encoding a transmitted data to generate an encoded signal, an interleaver 112 for interleaving the encoded signal to generate an interleaved signal, a QAM mapping unit 113 for modulating the interleaved signal to generate a modulated signal, and an inverse Fast Fourier Transform (IFFT) unit 114 for performing an IFFT on the modulated signal to generate a time-domain transformed signal and inputting the transformed signal to the channel emulator 116.

Next, the channel emulator 116 simulates a channel response of an external communication environment for attenuating the transformed signal to output a simulated signal. The random noise generator 117 also generates simulated noise and adds the simulated noise to the simulated signal. Hence, the signal finally outputted by the DAC 115 is a signal suffering from both channel attenuation and noise interference. After the ADC 125 receives the signal outputted by the DAC 115 and converts the signal from an analog format to a digital format, the signal is fed into and processed by the received data processing unit 128 in order to form an outputted data. Please note that operation of each unit in the received data processing unit 128 is the inverse of a corresponding unit in the transmitted data processing unit 118 and is well known to those skilled in the art, therefore descriptions of the operation of each unit in the received data processing unit 128 is omitted here for brevity. Finally, by analyzing the outputted signal of the received data processing unit 128, performance of the wireless communication apparatus 100 (for example, a graph representing the relationship between packet error rate (PER) and signal-to-noise ratio (SNR)) under channel attenuation and noise interference is obtained.

According to an embodiment of the present invention, the output signal of the DAC 115 is inputted to the ADC 125. However, the signal outputted by the channel emulator 116 and added to the simulated noise generated by the random noise generator 117 can be directly inputted to the received data processing unit 128 in another embodiment. Moreover, the channel emulator 116 and the random noise generator 117 need not be disposed in the wireless communication apparatus 100 at the same positions shown in FIG. 1. For example, the channel emulator 116 and the random noise generator 117 may change positions with each other, or the random noise generator 117 can be positioned at the output end of the ADC 125. These related position replacements all fall within the scope of the present invention. Furthermore, the channel emulator 116 and the random noise generator 117 can operate separately or simultaneously. For example, by enabling the random noise generator 117 and bypassing the channel emulator 116, performance of the wireless communication apparatus 100 under noise interference can be tested; by enabling the channel emulator 116 and bypassing the random noise generator 117, performance of the wireless communication apparatus 100 under channel attenuation can be tested; and by enabling both the channel emulator 116 and the random noise generator 117, performance of the wireless communication apparatus 100 under channel attenuation and noise interference can be tested. In other words, under a condition of not affecting the spirit of the present invention, any reasonable combinations of the channel emulator 116 and the random noise generator 117 shown in FIG. 1 can accomplish the objective of testing the performance of the wireless communication apparatus 100.

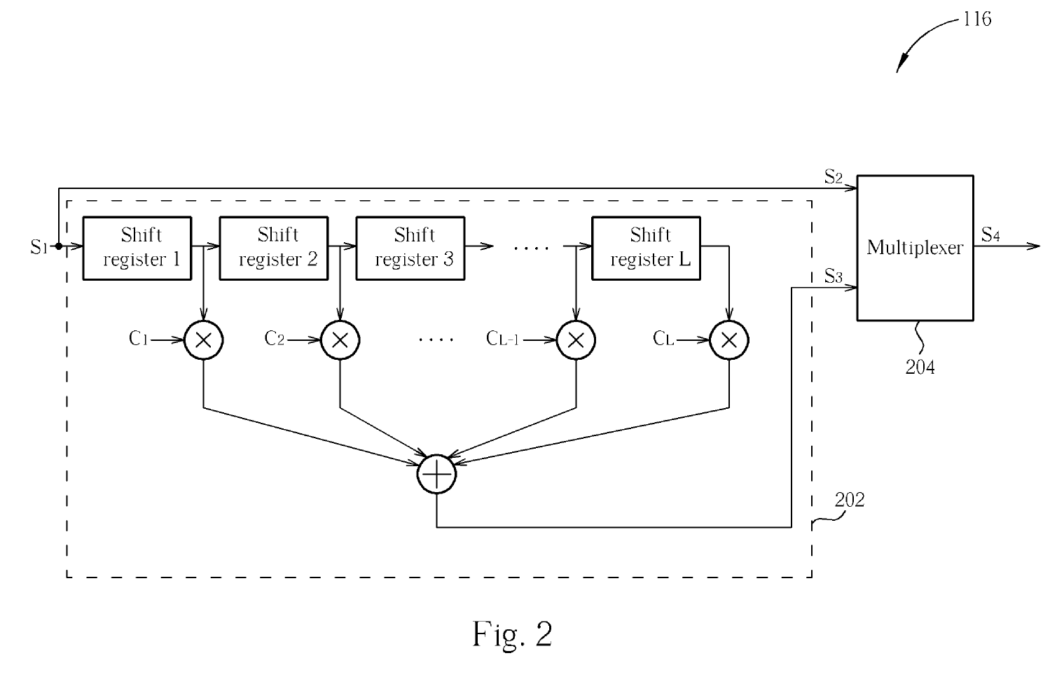

FIG. 2 is a diagram of the channel emulator 116 shown in FIG. 1 according to an exemplary embodiment of the present invention. The channel emulator 116 comprises a finite impulse response filter 202 and a multiplexer 204. The finite impulse response filter 202 is coupled to an input end S1 of the channel emulator 116, wherein the input end S1 receives the processed signal outputted by the received data processing unit 110. Parameters C₁ to C_{L} of the finite impulse response filter 202 can be adjusted by setting a control signal stored in a control register (not shown in FIG. 2) to simulate a variety of channel responses. The number of the parameters (i.e. the value of L) can be decided according to the requirements of testing. The multiplexer 204 comprises two input ends S2 and S3, and one output end S4, wherein the first input end S2 is coupled to the input end S1 of the channel emulator 116, the second input end S3 is coupled to the output end of the finite impulse response filter 202, and the output end S4 is coupled to the output end of the channel emulator 116. In this way, the multiplexer 204 can selectively output the processed signal generated by the transmitted data processing unit 110 or the simulated signal output by the finite impulse response filter 202 to the output end of the channel emulator 116 according to a selecting signal. In this embodiment, the multiplexer 204 outputs the simulated signal according to the selecting signal to perform testing when the wireless communication apparatus 100 is operated in the testing mode, and outputs the processed signal according to the selecting signal to perform signal transmission when the wireless communication apparatus 100 is utilized to transmit signals. It should be noted that the above structure is only an embodiment of the channel emulator 116, and is not meant to be a limitation of the implementations of the present invention. Therefore, other channel emulator structures able to obtain a substantially similar result (such as a channel emulator structure implementing an infinite impulse response filter) also fall within the scope of the present invention.

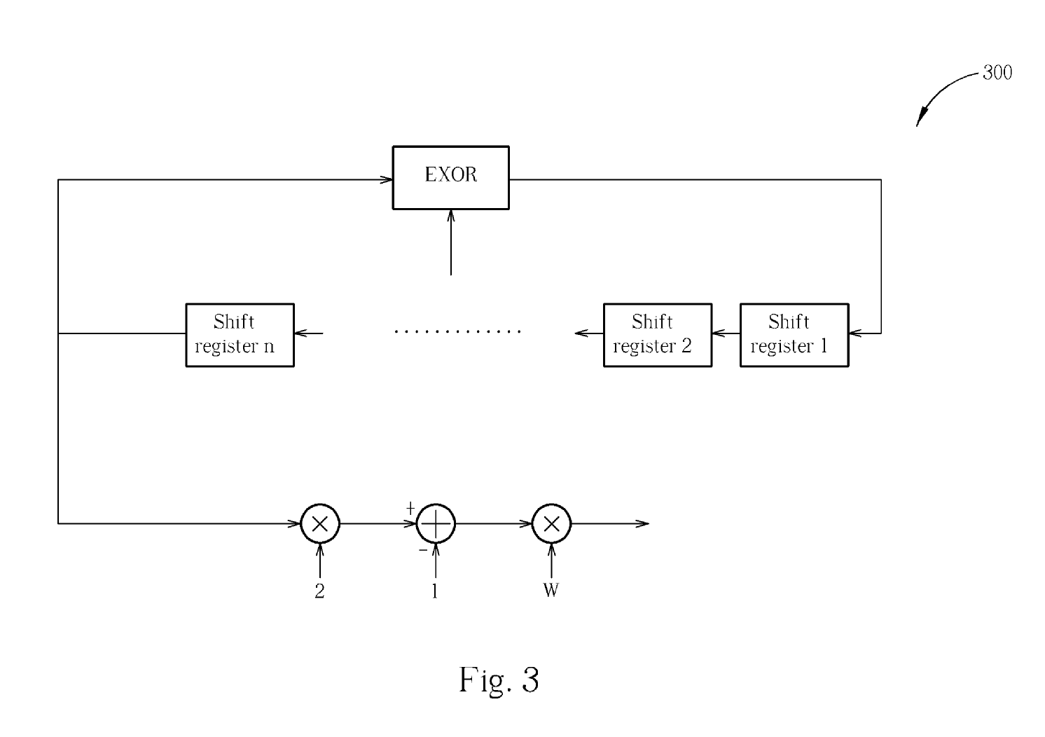

The present invention further provides a mechanism to simulate Additive White Gaussian Noise (AWGN) by utilizing a binary noise generator having a simple structure. Compared to the complex AWGN generator, the mechanism utilizing the binary noise generator can save production cost and complexity of the wireless communication apparatus 100. Please refer to FIG. 3, which is a diagram of a binary noise generator 300 implemented in the wireless communication apparatus 100 according to an exemplary embodiment of the present invention. The amplitude of the binary noise generated by the binary noise generator 300 is adjustable by setting a control signal stored in a control register (not shown in FIG. 3) to adjust parameter W. Please note that the binary noise generated by the binary noise generator 300 is independent and identically distributed (i.i.d). Therefore, according to the central limit theorem, after the binary noise is transformed by the IFFT unit 114 or the FFT unit 124, the binary noise is equivalent to AWGN at the output end of the IFFT unit 114 or the FFT unit 124. Based on this principle, when the random noise generator 117 is implemented by the binary noise generator 300 of FIG. 3, AWGN required to simulate noise interference can be generated by the binary noise generator 300 having simple structure and original units (i.e. IFFT unit 114 and FFT unit 124) of the wireless communication apparatus 100 through coupling the random noise generator 117 preceding the IFFT unit 114 or the FFT unit 124. In other words, the combination of the binary noise generator 300 and the IFFT unit 114/FFT unit 124 is substantially equivalent to an AWGN generator. In this way, the overall simulation results will be much closer to the real transmission performance in the external environment.

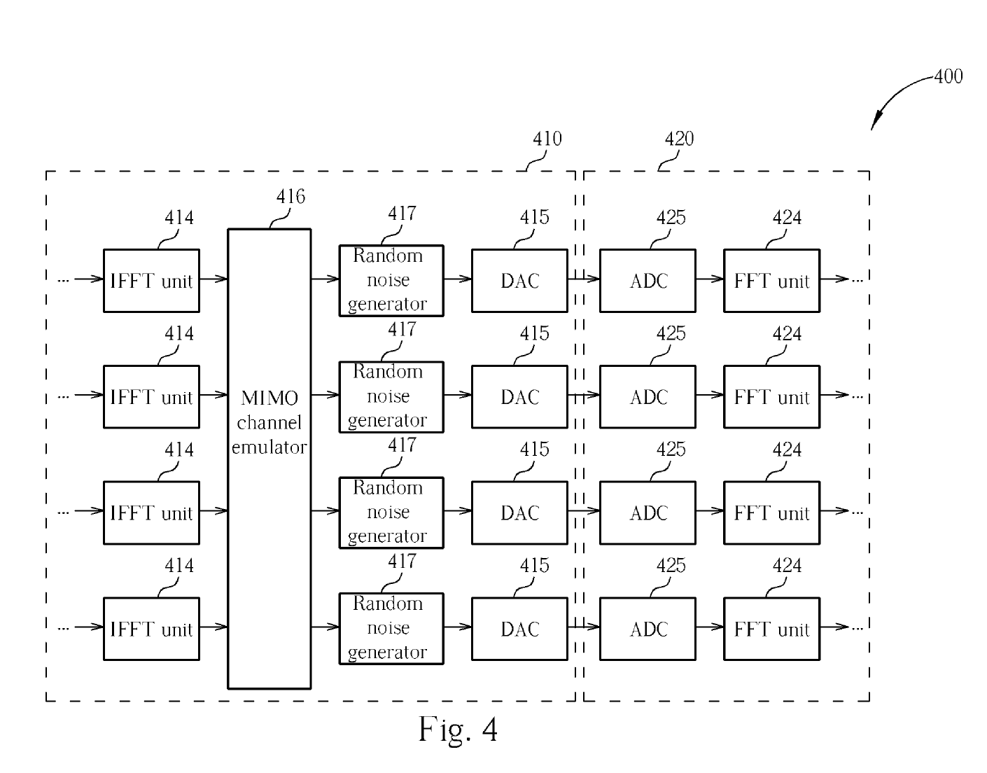

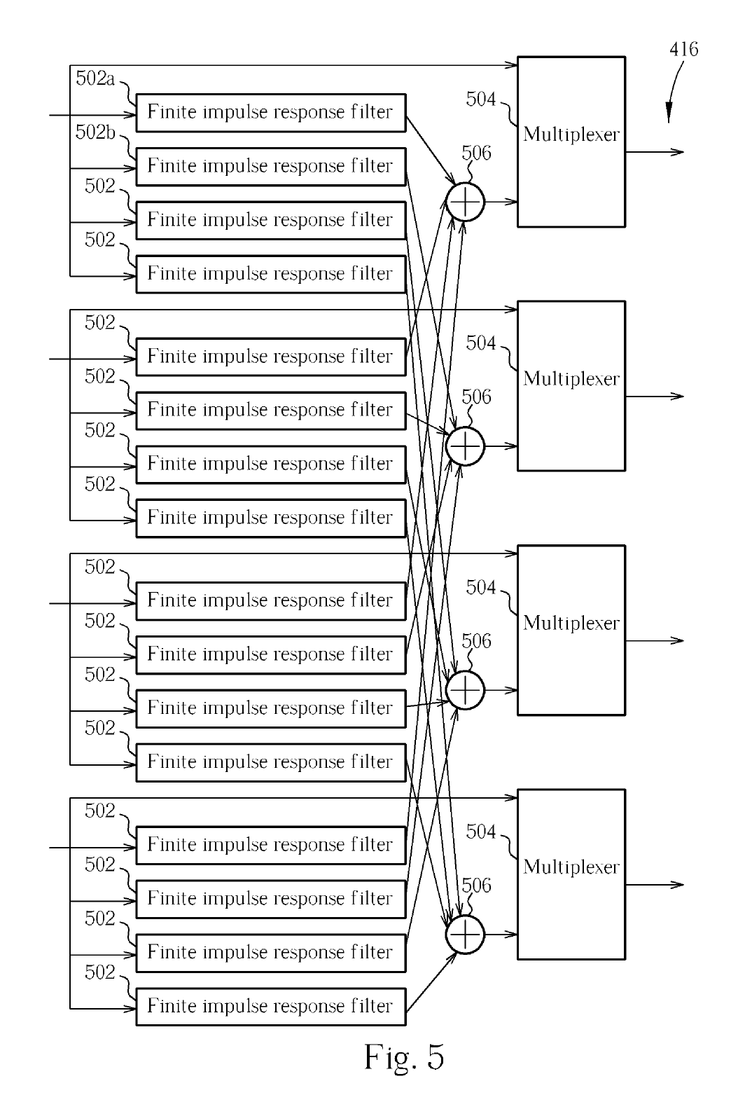

Please refer to FIG. 4, which is a diagram of a wireless communication apparatus 400 of a multiple-input multiple-output (MIMO) OFDM system according to an exemplary embodiment of the present invention. Similar to the SISO system shown in FIG. 1, a MIMO channel emulator 416 and a plurality of random noise generators 417 are coupled between an IFFT unit 414 and a DAC 415 of a transmitting module 410 of the wireless communication apparatus 400. Since a person skilled in the art can easily appreciate the structures of the transmitting module and a receiving module of the wireless communication apparatus 400 from FIG. 1, other units of the transmitting module 410 and the receiving module 420 are omitted in FIG. 4 for brevity. In this embodiment, the random noise generator 417 in one path is utilized to simulate noise received by one receiving antenna, and has the same structure and operation as the random noise generator 117 in FIG. 1. The MIMO channel emulator 416 is utilized to simulate multi-path response between multiple transmitting antennas and multiple receiving antennas. Taking a MIMO system having four transmitting antennas and four receiving antennas as an example, the MIMO channel emulator 416 of this MIMO system is shown in FIG. 5. Each finite impulse response filter 502 is utilized to simulate a channel response between a specific transmitting antenna and a specific receiving antenna. For example, the finite impulse response filter 502a is utilized to simulate a channel response between a first transmitting antenna and a first receiving antenna; and the finite impulse response filter 502b is utilized to simulate a channel response between the first transmitting antenna and a second receiving antenna. Therefore, the MIMO channel emulator 416 comprises 16 finite impulse response filters 502, and the output of each adder 506 represents an attenuated signal received by each receiving antenna because a receiving antenna of the MIMO system receives signals transmitted by every transmitting antenna. Similar to the multiplexer 204 in the channel emulator 116 shown in FIG. 2, an objective of the multiplexer 504 is to allow the MIMO channel emulator 416 to output the processed signal generated by the FFT unit without enabling the finite impulse response filters 502 when the wireless communication apparatus 400 is not operated in the test mode. The finite impulse response filters 502 can be configured to simulate a variety of multi-path responses by setting a control signal stored in a control register (not shown in FIG. 5), wherein the control signal configures the finite impulse response filters 502 by adjusting the parameters of the finite impulse response filters 502. The number of parameters depends on the requirements of the system. Moreover, under a condition of substantially obtaining a same result, part of the finite impulse response filters 502 can be removed from the MIMO channel emulator 416 in order to decrease the circuit complexity. It should be noted that the above structure is only an embodiment of the MIMO channel emulator 416, and is not meant to be a limitation of the implementations of the present invention. Other MIMO channel emulator structures able to obtain a substantially same result (such as a channel emulator structure implementing infinite impulse response filters) also fall within the scope of the present invention.

Similar to the wireless communication apparatus 100 of FIG. 1, the MIMO channel emulator 416 and the random noise generators 417 of the wireless communication apparatus 400 need not be disposed at the same positions shown in FIG. 4. For example, the MIMO channel emulator 416 and the random noise generators 417 may change positions with each other, or the MIMO channel emulator 416 and the random noise generator 417 can be disposed at any position between a QAM de-mapping unit (not shown) and the IFFT unit 414. Furthermore, the MIMO channel emulator 416 and the random noise generators 417 can operate separately or simultaneously. The transmitting module 410 and the receiving module 420 need not include the MIMO channel emulator 416 and the random noise generators 417 at the same time: when one of the transmitting module 410 and the receiving module 420 has the MIMO channel emulator 416, the wireless communication apparatus 400 can simulate the multi-path attenuation of external transmission environment. When one of the transmitting module 410 and the receiving module 420 has the random noise generators 417, the wireless communication apparatus 400 can simulate the noise interference of the external transmission environment.

In the above embodiments, both the wireless communication apparatuses 100 and 400 comprise a transmitting module and a receiving module, and the signal output by the transmitting module is transmitted directly by a loopback to the receiving module in the same chip for decoding and testing. However, the present invention is not limited to generate a modulated signal and demodulate the modulated signal in the same chip.

In another embodiment of testing a chip's performance, a transmitting module of a first communication chip (e.g. the wireless communication apparatus 100 or 400) is connected to a receiving module of a second communication chip (e.g. the wireless communication apparatus 100 or 400) via a cable, and a channel emulator or/and a random noise generator is disposed in the transmitting module and/or the receiving module.

Those skilled in the art will readily observe that numerous modifications and alterations of the device and method may be made while retaining the teachings of the invention.

What is claimed is:

1. A network communication apparatus, comprising:
a transmitted data processing unit, for processing transmitted data to output a processed signal;
a channel simulating unit, coupled to the transmitted data processing unit, for simulating channel statuses, wherein the channel simulating unit simulates a channel response on the processed signal to output a simulated signal; and
a selecting unit, for receiving the processed signal and the simulated signal, and selectively outputting one of the processed signal and the simulated signal according to a selecting signal;
wherein the selecting unit outputs the simulated signal for testing according to the selecting signal when the network communication apparatus is operated in a test mode, and outputs the processed signal for transmission according to the selecting signal when the network communication apparatus is utilized to transmit signals.

2. The network communication apparatus of claim 1, further comprising:
a noise generator, coupled to the selecting unit, for generating a simulated noise to the simulated signal output by the selecting unit.

3. The network communication apparatus of claim 2, wherein the noise generator is a binary noise generator.

4. The network communication apparatus of claim 1, wherein the transmitted data processing unit further comprises:
an encoder, for encoding the transmitted data to generate an encoded signal;
an interleaver, coupled to the encoder, for interleaving the encoded signal to output an interleaved signal;
a QAM mapping unit, coupled to the interleaver, for modulating the interleaved signal to generate a modulated signal; and
an inverse Fourier transform unit, coupled to the QAM mapping unit, for transforming the modulated signal to generate the processed signal.

5. The network communication apparatus of claim 1, wherein the channel simulating unit is a finite impulse response filter.

6. The network communication apparatus of claim 1, further comprising:
a control register, coupled to the channel simulating unit, for storing a control signal to adjust the channel statuses simulated by the channel simulating unit.

7. The network communication apparatus of claim 1, further comprising:
a received data processing unit, for processing the simulated signal outputted by the selecting unit to output an output data, wherein the output data is substantially equal to the transmitted data.

8. The network communication apparatus of claim 1, wherein the processed signal is a time-domain signal outputted by an inverse Fourier transform unit.

9. The network communication apparatus of claim 1, implemented in a multiple-input multiple-output (MIMO) system.

10. The network communication apparatus of claim 1, implemented in an orthogonal frequency division multiplexing (OFDM) system.

11. A network communication apparatus, comprising:
a transmitted data processing unit, for processing a transmitted data to output a processed signal;
a channel simulating unit, coupled to the transmitted data processing unit, for simulating channel statuses, wherein the channel simulating unit simulates a channel response on the processed signal outputted by the transmitted data processing unit to output a simulated signal; and
a received data processing unit, for processing the simulated signal outputted by the channel simulating unit to output an output data.

12. The network communication apparatus of claim 11, further comprising:
a noise generator, coupled to the channel simulating unit, for generating a simulated noise to the simulated signal.

13. The network communication apparatus of claim 12, wherein the noise generator is a binary noise generator.

14. The network communication apparatus of claim 11, wherein the channel simulating unit is a finite impulse response filter.

15. The network communication apparatus of claim 11, further comprising:
a control register, coupled to the channel simulating unit, for storing a control signal to adjust the channel statuses simulated by the channel simulating unit.

16. The network communication apparatus of claim 11, wherein the processed signal is a time-domain signal outputted by an inverse Fourier transform unit.

17. The network communication apparatus of claim 11, implemented in a MIMO system.

18. The network communication apparatus of claim 11, implemented in an OFDM system.
